(19) United States
(12) Patent Application Publication
(10) Pub. No.: US 2004/0128572 A1
(43) Pub. Date: Jul. 1, 2004

(54) Apparatus and method for driving and routing source operands to execution units in layout stacks

(76) Inventors: Nadav Bonen, Nahariya (IL); Zeev Sperber, Zichron Yaakov (IL); Oded Liron, Givaat Ada (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/331,604

(22) Filed: Dec. 31, 2002

(51) Int. Cl. G06F 1/26

(52) U.S. Cl. 713/320

(57) ABSTRACT

In some embodiments of the present invention, a processor includes a reservation station having one or more source ports and two or more layout stacks each having one or more execution units. Each execution unit is assigned to a source port. The processor may be able to drive one or more operands of a micro-instruction via one of the source ports to an execution unit in a layout stack without driving the operands to execution units in other layout stacks that are assigned to the same source port.

### BACKGROUND OF THE INVENTION

Processors may comprise several types of execution units (EU), and each may be dedicated and optimized for performing specific tasks. Although not limited in this respect, examples for such EUs may be integer EUs for manipulating operands in integer format, floating point EUs for manipulating operands in floating point format, jump EUs for executing program branches, and multimedia EUs for performing specific multimedia and communication instructions, such as, for example, Multi Media extensions (MMX™) instructions. Moreover, processors may also have more than one EU of each type. A processor comprising several EUs may be able to operate each EU independently and consequently will be able to execute several micro-operations in parallel.

The processor may also comprise a reservation station (RS) unit, responsible for dispatching micro-instructions to the different EUs. The RS may have several ports, and each port may be coupled to one or more EUs and used to dispatch micro-instructions to these EUs.

It will be appreciated by persons of ordinary skill in the art of processor design that when a processor comprises several EUs of different types and different physical sizes, it may be desired to arrange the EUs in physical groups (“layout stacks”) to reduce die area. Each layout stack may comprise EUs that may be coupled to different ports of the RS, and consequently, signals of one port of the RS unit may be routed to more than one layout stack. Since the layout stacks may be distant from one another, this may consume a lot of power.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a simplified block diagram of an apparatus comprising a processor in accordance with some embodiments of the present invention; and

FIG. 2 is a simplified block-diagram illustration of a processor according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

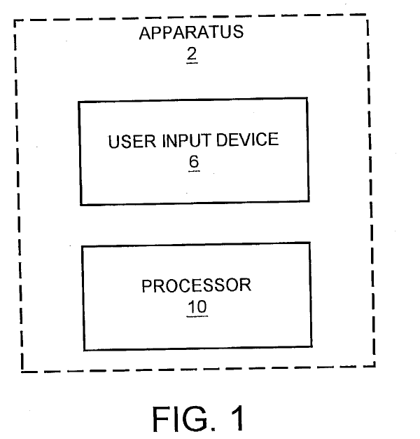

It should be understood that the present invention may be used in a variety of applications. As shown in FIG. 1, an apparatus 2 may comprise a processor 10 according to some embodiments of the present invention. The apparatus may be a portable device that may be powered by a battery. Non-limiting examples of such portable devices include laptop and notebook computers, mobile telephones, personal digital assistants (PDA) and the like. Alternatively, the apparatus may be a non-portable device, such as, for example, a desktop computer. Apparatus 2 may comprise a user-input device 6, such as, for example, a full or partial keyboard, a touch-pad, a trackball, a touch screen, a microphone, a dial pad, and the like.

Design considerations, such as, but not limited to, processor performance and cost, may result in a particular processor design. The processor design may dictate the number of EUs of each type, the number of ports of the RS, the assignment of the EUs to the ports of the RS, and the logic used in the RS for dispatching micro-instructions to the EUs. The processor design may also dictate the arrangement of EUs into physical groups known as “layout stacks”.

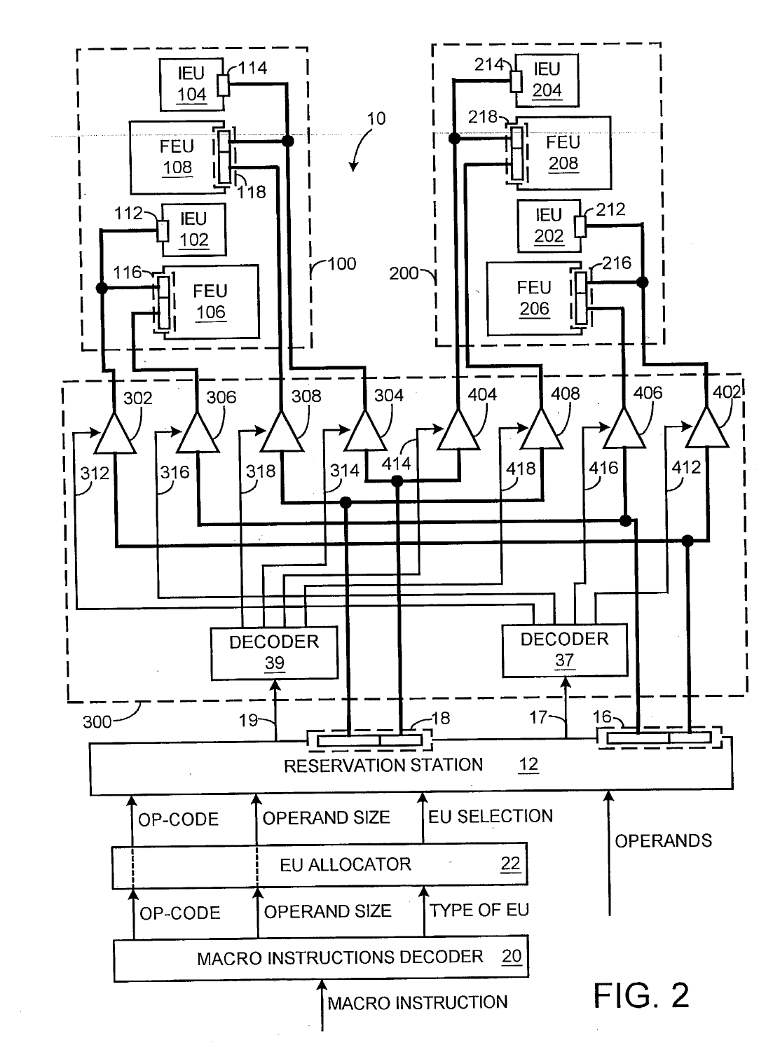

FIG. 2 is a simplified block-diagram illustration of an exemplary embodiment for processor 10, in accordance with some embodiments of the present invention. Well-known components and circuits of processor 10 are not shown in FIG. 2 so as not to obscure the invention. Although the scope of the present invention is not limited in this respect, processor 10 may be, for example, a central processing unit (CPU), a digital signal processor (DSP), a reduced instruction set computer (RISC), a complex instruction set computer (CISC), and the like. Moreover, processor 10 may be part of an application specific integrated circuit (ASIC).

The following description makes use of an exemplary processor comprising two layout stacks 100 and 200, each comprising two integer EUs (IEUs) 102 and 104, and 202 and 204, respectively, and two floating point EUs (FEUs) 106 and 108, and 206 and 208, respectively. The processor also comprises a reservation station 12 comprising a source port 16 to dispatch source operands to one integer EU and one floating point EU of each of the layout stacks, and another source port 18 to dispatch source operands to the other integer EUs and floating point EUs of the layout stacks.

It will be appreciated by persons of ordinary skill in the art of processor design that many other configurations are possible, all of which are within the scope of the present invention. For example, a processor according to some embodiments of the present invention may comprise a different number of layout stacks than that shown in FIG. 2. In another example, different layout stacks may comprise a different number of EUs. In yet another example, the layout stacks may comprise a different variety of EUs rather than the combination of two integer EUs and two floating point EUs shown in FIG. 2. In particular, the layout stacks may comprise one or more jump EUs and/or one or more multimedia EUs, such as for example, EUs able to execute multimedia related operations such as for example Multi Media extensions (MMX™) operations. In a further example, the number of ports of the RS and/or the assignment of EUs to the ports may be different than shown in FIG. 2.

Integer EUs 102 and 104 may comprise source ports 112 and 114, respectively, for 32-bit operands. Similarly, integer EUs 202 and 204 may comprise source ports 212 and 214, respectively, for 32-bit operands. Floating point EUs 106 and 108 may comprise source ports 116 and 118, respectively, for 86-bit operands. Similarly, floating point EUs 206 and 208 may comprise source ports 216 and 218, respectively, for 86-bit operands.

Port 16 of reservation station 12 may be used to dispatch source operands to integer EUs 102 and 202 and to floating point EUs 106 and 206. Similarly, port 18 of reservation station 12 may be used to dispatch source operands to integer EUs 104 and 204 and to floating point EUs 108 and 208.

If all the EUs assigned to a particular port of the reservation station were coupled to that particular port directly using a common set of traces, then when the particular port would dispatch source operands to one of its assigned EUs, the signals from the particular port would toggle all along the common set of traces. For example, if source data from port 16 were destined for an EU in layout stack 100, signals from port 16 would toggle also on the part of the common set of traces that reach layout stack 200, and vice versa. In another example, even when the source operand is 32 bits wide, all 86 bits would be driven by port 16. Therefore, the power consumption associated with source operands dispatched from a source port of the reservation station to any of its assigned EUs would be proportional to the sum of the frequencies at which source operands are dispatched to each of the port's assigned EUs. As is known in the art, the power consumption is proportional to the capacitance associated with the set of traces. This capacitance comprises the capacitance of the traces and the relatively smaller capacitance of the ports. Consequently, the relationship between the power consumption, the capacitance and the frequencies may be expressed by the following equations:

P[port 16]∝C[port 16]·{f(EU 102)+f(EU 106)+f(EU 202)+f(EU 206)} (Eqn. 1)

P[port 18]∝C[port 18]·{f(EU 104)+f(EU 108)+f(EU 204)+f(EU 208)} (Eqn. 2)

where P[port 16] (P[port 18]) denotes the power consumption associated with source operands dispatched from port 16 (18), C[port 16] (C[port 18]) denotes the capacitance of the common set of traces coupling port 16 (18) to the EUs assigned to it, and f(EU XXX) denotes the frequency at which source operands are dispatched to EU XXX, where XXX may be the reference numeral of an EU assigned to port 16 (18).

In contrast, if the EUs were coupled to their assigned ports of the reservation station using dedicated sets of traces, each with its own capacitance and carrying signals at a particular associated frequency, then the power consumption associated with source operands dispatched from port 16 (18) of reservation station 12 would be different than that given in Eqn. 1 (2). In general terms, the power consumption associated with source operands dispatched from a given source port of the reservation station, P[port], would be related to the capacitances and associated frequencies of the dedicated sets of traces as expressed in the following equation:

P[port]∝C[set1]·f[set1]+C[set2]·f[set2]+C[set3]·f[set3]+ . . . ,

where C[set1] denotes the capacitance of the first dedicated set of traces, and f[set1] denotes the frequency at which source operands are dispatched from the port to EUs coupled to the port by the first dedicated set of traces.

By proper choice of dedicated sets of traces, the power consumption associated with operands dispatched from a given port may be reduced relative to the power consumption in the case of direct coupling with common sets of traces. For example, it is known in the art that the capacitance of traces is dominated by their length, therefore choosing dedicated sets of traces that are shorter than the common sets of traces may reduce the power consumption relative to the power consumption in the case of direct coupling with common sets of traces. Although the scope of the present invention is not limited in this respect, this reduction in power consumption may be significant relative to the total power consumption of the processor.

As will be explained in more detail below, in some embodiments of the present invention, reservation station 12 may drive data from a port to a destination EU in one of the layout stacks without driving the data to EUs in the other layout stack that are also assigned to the same port of the reservation station. Moreover, in some embodiments of the present invention, when the operand is 32 bits wide, reservation station 12 may drive the operand to a destination EU without driving all 86 bits of the port. Furthermore, in some embodiments of the present invention, when a micro-instruction is executed without any operands, reservation station 12 may not drive any of the bits of the port.

In some embodiments of the present invention, the layout stacks may be coupled to the reservation station by a routing and buffering circuit 300. Routing and buffering circuit 300 may be physically close to reservation station 12, although the scope of the present invention is not limited in this respect. Routing and buffering circuit 300 may comprise decoders 37 and 39 to receive encoded signals from reservation station 12 and to control buffer groups in routing and buffering circuit 300. Although FIG. 2 shows a buffer group for each execution unit, in alternative embodiments of the present invention, more than one execution unit may be coupled to the same buffer group.

Routing and buffering circuit 300 may comprise a buffer group 302 coupling the low bits of port 16 of reservation station 12 to port 112 of integer EU 102 and to the low bits of port 116 of floating point EU 106. If two or more source operands are being dispatched substantially simultaneously by port 16, then the term “low bits of port 16” refers to the bits of port 16 that drive the low bits of each of the source operands, and the term “high bits of port 16” refers to the bits of port 16 that drive the high bits of each of the source operands. Similarly for the terms “low bits of port 116” and “high bits of port 116”. A control-input signal 312 may be generated by decoder 37 and sent to buffer group 302. When control-input signal 312 is in a first state, buffer group 302 may drive signals (bits 0-31 of the operands) from port 16 to port 112 and the low bits of port 116. When control-input signal 312 is in a second state, buffer group 302 may prevent signals from port 16 from being passed to port 112 and the low bits of port 116, and the output of buffer group 302 may maintain the logic values of the input at the instant control-input signal 312 changed into the second state.

Similarly, routing and buffering circuit may comprise a buffer group 402 that is similar to buffer group 302 but couples the low bits of port 16 of reservation station 12 to port 212 of integer EU 202 and to the low bits of port 216 of floating point EU 206. A control-input signal 412 may control the operation of buffer group 402 in the same manner that control-input signal 312 may control the operation of buffer group 302.

Routing and buffering circuit 300 may comprise a buffer group 304 coupling the low bits of port 18 of reservation station 12 to port 114 of integer EU 104 and the low bits of port 118 of floating point EU 108. A control-input signal 314 may be generated by decoder 39 and sent to buffer group 304. When control-input signal 314 is in a first state, buffer group 304 may drive signals (bits 0-31 of the operands) from port 18 to port 114 and the low bits of port 118. When control-input signal 314 is in a second state, buffer group 304 may prevent signals from port 18 from being passed to port 114 and the low bits of port 118, and the output of buffer group 304 may maintain the logic values of the input at the instant control-input signal 314 changed into the second state.

Similarly, routing and buffering circuit may comprise a buffer group 404 that is similar to buffer group 304 but couples the low bits of port 18 of reservation station 12 to port 214 of integer EU 204 and to the low bits of port 218 of floating point EU 208. A control-input signal 414 may control the operation of buffer group 404 in the same manner that control-input signal 314 may control the operation of buffer group 304.

Routing and buffering circuit 300 may comprise a buffer group 306 coupling the high bits of port 16 of reservation station 12 to the high bits of port 116 of floating point EU 106. A control-input signal 316 may be generated by decoder 37 and sent to buffer group 306. When control-input signal 316 is in a first state, buffer group 306 may drive signals (bits 32-85 of the operands) from port 16 to the high bits of port 116. When control-input signal 316 is in a second state, buffer group 306 may prevent signals from port 16 from being passed to the high bits of port 116, and the output of buffer group 306 may maintain the logic values of the input at the instant control-input signal 316 changed into the second state.

Similarly, routing and buffering circuit may comprise a buffer group 406 that is similar to buffer group 306 but couples the high bits of port 16 of reservation station 12 to the high bits of port 216 of floating point EU 206. A control-input signal 416 may control the operation of buffer group 406 in the same manner that control-input signal 316 may control the operation of buffer group 306.

Routing and buffering circuit 300 may comprise a buffer group 308 coupling the high bits of port 18 of reservation station 12 to the high bits of port 118 of floating point EU 108. A control-input signal 318 may be generated by decoder 39 and sent to buffer group 308. When control-input signal 318 is in a drive state, buffer group 308 may drive signals (bits 32-85 of the operands) from port 18 to the high bits of port 118. When control-input signal 318 is in a second state, buffer group 308 may prevent signals from port 18 from being passed to the high bits of port 118, and the output of logic group 308 may maintain the logic values of the input at the instant control-input signal 318 changed into the second state.

Similarly, routing and buffering circuit may comprise a buffer group 408 that is similar to buffer group 308 but couples the high bits of port 18 of reservation station 12 to the high bits of port 218 of floating point EU 208. A control-input signal 418 may control the operation of buffer group 408 in the same manner that control-input signal 318 may control the operation of buffer group 308.

Processor 10 may comprise a macro-instruction decoder 20 to receive macro-instructions and to decode each macro-instruction into one or more micro-instructions, depending upon the type of the macro-instruction. A micro-instruction is an operation to be executed by one of the EUs of layout stacks 100 and 200. A single macro-instruction may be decoded into micro-instructions of different types, each to be executed by a corresponding type of EU. The type of micro-instruction is encoded in a field of the micro-instruction known as an “op-code”. Macro-instruction decoder 20 may also generate signals indicating the size of the operands and the type of EU for executing the micro-instruction.

Processor 10 may also comprise an EU allocator 22 coupled to macro-instruction decoder 20 and to reservation station 12. EU allocator 22 may receive the op-code, operand size indication and type of EU indication signals from macro-instruction decoder 20, and may decide which of the EUs of layout-stack 100 and layout stack 200 is to execute the micro-instruction. After making this decision, EU allocator 22 may forward the op-code, the operand size indication and the selected EU indication signals to reservation station 12.

Reservation station 12 may use the operand size indication and the selected EU indication to generate encoded buffer control signals that are stored internally in the reservation station along with the op-code. Once reservation station 12 has received the operands for the micro-instruction, it may store the operands internally until the selected EU and its associated port are available. At that time, reservation station 12 may send the operands to the selected EU via its associated port, may send the micro-instruction's op-code to the selected EU via traces (not shown), and may send the corresponding encoded buffer control signals to the appropriate decoder in routing and buffering circuit 300. For example, if the associated port of the selected EU is port 16 (18), then reservation station 12 may generate encoded buffer control signals 17 (19) to be sent to decoder 37 (39).

Decoder 37 may convert the encoded buffer control signals 17 into control-input signals 312, 316, 412 and 416 based on the physical arrangement of the EUs assigned to port 16 into layout stacks. Similarly, decoder 39 may convert the encoded buffer control signals 19 into control-input signals 314, 318, 414 and 418 based on the physical arrangement of the EUs assigned to port 18 into layout stacks. In this embodiment, the design of the reservation station 12 may be independent of the physical arrangement of the EUs into layout stacks.

Alternatively, reservation station 12 may use the operand size indication and the selected EU indication to directly generate control-input signals 312, 314, 316, 318, 412, 414, 416, and 418 based on the physical arrangement of the EUs assigned to into layout stacks. However, in this alternative embodiment, the design of reservation station 12 may not be independent of the physical arrangement of the EUs into layout stacks.

It was mentioned hereinabove that design considerations, such as, but not limited to, processor performance and cost, may result in a particular processor design. It was mentioned that the processor design may dictate the number of EUs of each type, the number of ports of the RS, the assignment of the EUs to the ports of the RS, and the logic used in the RS for dispatching micro-instructions to the EUs. It was also mentioned that the processor design may also dictate the arrangement of EUs into physical groups known as “layout stacks”.

However, having a processor according to some embodiments of the invention may produce more flexibility for new processor designs. For example, with the possibility of using a routing and buffering circuit as described hereinabove, the processor designer may decide to develop a different processor design. Some embodiments of the present invention may enable new designs to overcome layout constraints. For example, some execution units may be located even farther from their assigned reservation station port than in the case of a processor coupling execution units to their assigned reservation station port using a common set of traces.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method comprising:
driving one or more operands of a micro-instruction via a port to an execution unit in a layout stack without driving said operands to execution units in other layout stacks that are assigned to said port.

2. The method of claim 1, wherein driving said operands to said execution unit comprises:
enabling a buffer coupled between said port and said execution unit to drive said operands to said execution unit; and
not enabling buffers coupled between said port and said execution units to drive said operands to said execution units.

3. The method of claim 2, wherein enabling said buffer comprises:
converting encoded buffer control signals representing an identification of said execution unit to execute said micro-instruction into a control-input signal for said buffer.

4. The method of claim 1, further comprising:
driving one or more operands of said micro-instruction via said port to said execution unit, wherein said operands are narrower than a width of said port, without driving bits of said port exceeding a width of said operands.

5. A method comprising:
blocking bits of one or more operands driven by a particular source port from arriving at at least one of a group of execution units assigned to said particular source port.

6. The method of claim 5, wherein bits comprise all bits of said operands.

7. The method of claim 5, wherein blocking said bits comprises blocking a portion of all bits of said operands.

8. An apparatus comprising:
a processor comprising:
a reservation station having one or more source ports;
two or more layout stacks each comprising one or more execution units, each of said execution units assigned to one of said source ports; and
a routing and buffering circuit coupled to said reservation station and to said execution units.

9. The apparatus of claim 8, wherein said routing and buffering circuit comprises:
a buffer group to block bits of one or more operands driven by a particular one of said source ports from arriving at at least one of said execution units assigned to said particular one of said source ports.

10. The apparatus of claim 9, wherein said bits comprise all bits of said operands.

11. The apparatus of claim 9, wherein said buffer group is able to block a portion of all bits of said operands.

12. The apparatus of claim 8, wherein said buffering and routing circuit comprises:
a first buffer group to drive one or more operands of a micro-instruction via a particular one of said source ports to an execution unit assigned to said particular one of said source ports, said execution unit in a particular one of said layout stacks; and
a second buffer group to prevent said operands from being driven to execution units in other of said layout stacks.

13. The apparatus of claim 12, wherein said routing and buffering circuit further comprises:
a decoder to convert encoded buffer control signals from said reservation station, said encoded buffer control signals representing an identification of said execution unit to execute said micro-instruction, to a control-input signal for said first buffer group.

14. The apparatus of claim 12, wherein said reservation station is able to generate a control-input signal for said first buffer group.

15. A portable apparatus comprising:
a user-input device; and
a processor comprising:
a reservation station having one or more source ports;
two or more layout stacks each comprising one or more execution units, each of said execution units assigned to one of said source ports; and
a routing and buffering circuit coupled to said reservation station and to said execution units.

16. The portable apparatus of claim 15, wherein said routing and buffering circuit comprises:
a buffer group to block bits of one or more operands driven by a particular one of said source ports from arriving at at least one of said execution units assigned to said particular one of said source ports.

17. The portable apparatus of claim 16, wherein said bits comprise all bits of said operands.

18. The portable apparatus of claim 16, wherein said buffer group is able to block a portion of all bits of said operands.

19. The portable apparatus of claim 15, wherein said buffering and routing circuit comprises:
a first buffer to drive one or more operands of a micro-instruction via a particular one of said source ports to an execution unit assigned to said particular one of said source ports, said execution unit in a particular one of said layout stacks; and
a second buffer to prevent said operands from being driven to execution units in other of said layout stacks.
